(19) United States
(12) Patent Application Publication
(10) Pub. No.: US 2011/0292855 A1
(43) Pub. Date: Dec. 1, 2011

(54) DYNAMIC CLOCK BUFFER POWER OPTIMIZATION BASED ON MODES OF OPERATION

(75) Inventors: Juhi Saha, San Diego, CA (US); Brett Walker, San Diego, CA (US); Chris Rosolowski, San Diego, CA (US); Soon-Seng Lau, San Diego, CA (US)

(73) Assignee: QUALCOMM Incorporated, San Diego, CA (US)

(21) Appl. No.: 13/118,232

(22) Filed: May 27, 2011

Related U.S. Application Data
(60) Provisional application No. 61/349,751, filed on May 28, 2010.

(51) Int. Cl. H04W 52/02

(52) U.S. Cl. 370/311

(57) ABSTRACT

Circuitry configured for dynamically adjusting clock signal quality based on an operating mode for power savings is described. The circuitry includes clock generation circuitry. The circuitry also includes mode control circuitry. The mode control circuitry provides a drive signal based on an operating mode. The circuitry also includes clock buffer circuitry coupled to the clock generation circuitry and to the mode control circuitry. The clock buffer circuitry adjusts a clock signal quality based on the drive signal.

### RELATED APPLICATIONS

This application is related to and claims priority from U.S. Provisional Patent Application Ser. No. 61/349,751 filed May 28, 2010 for “DYNAMIC CLOCK BUFFER POWER OPTIMIZATION BASED ON MODES OF OPERATION.”

### TECHNICAL FIELD

The present disclosure relates generally to electronic devices. More specifically, the present disclosure relates to dynamically adjusting clock buffer circuitry for power conservation.

### BACKGROUND

In the last several decades, the use of electronics has become common. In particular, advances in electronic technology have reduced the cost of increasingly complex and useful electronic devices. Cost reduction and consumer demand have proliferated the use of electronic devices such that they are practically ubiquitous in modern society. As the use of electronic devices has expanded, so has the demand for new and improved features of electronics. More specifically, electronic devices that perform functions faster, more efficiently or with higher quality are often sought after.

Many electronic devices (e.g., electronic circuits, cellular phones, smart phones, computers, etc.) use clock signals. These electronic devices may use clock signals for various purposes. For example, an electronic device may use a clock signal to time processing operations, to perform signal processing, to track time, to transmit and/or receive signals, etc. For instance, a cellular phone may use a clock signal for signal processing (e.g., modulation/demodulation, encoding, etc.) and coordinating communications. In another instance, a computer may use a clock signal to time processing operations.

Clock signals are often derived from a source such as a physical crystal, whose output is often processed in order to improve their quality. For example, some devices or components may require higher quality clock signals than others. However, processing clock signals requires electrical power. Increased electrical power is often needed to produce increased clock signal quality. Providing a higher quality clock signal than is required may thus consume more electrical power than is needed, thus wasting energy. Systems and methods that help to conserve power may be beneficial.

### SUMMARY

Circuitry configured for dynamically adjusting clock signal quality based on an operating mode for power savings is disclosed. The circuitry includes clock generation circuitry. The circuitry also includes mode control circuitry. The mode control circuitry provides a drive signal based on an operating mode. The circuitry also includes clock buffer circuitry coupled to the clock generation circuitry and to the mode control circuitry. The clock buffer circuitry adjusts a clock signal quality based on the drive signal. The clock generation circuitry may include a crystal and crystal oscillator circuitry.

The clock signal quality may be continually adjusted based on an operating mode indicator. A drive signal strength may be reduced and the clock signal quality may be reduced for a reduced quality operating mode. Reducing the drive signal strength may conserve power. A drive signal strength may be increased and the clock signal quality may be increased for a highest quality operating mode.

The operating mode may be based on the clock signal quality required for proper operation of recipient circuitry. The clock signal quality may be based on one of a group consisting of phase noise, frequency drift, amplitude, temperature compensation, jitter and another clock quality parameter.

The mode control circuitry and the clock buffer circuitry may be included in a power management circuit. The mode control circuitry and the clock buffer circuitry may be included in an electronic device.

A method for dynamically adjusting clock signal quality by circuitry based on an operating mode for power savings is also disclosed. The method includes generating a clock signal. The method also includes providing a drive signal based on an operating mode. The method further includes adjusting a clock signal quality based on the drive signal.

A computer-program product for dynamically adjusting clock signal quality based on an operating mode for power savings is also disclosed. The computer-program product includes a non-transitory tangible computer-readable medium with instructions. The instructions include code for causing circuitry to generate a clock signal. The instructions also include code for causing the circuitry to provide a drive signal based on an operating mode. The instructions further include code for causing the circuitry to adjust a clock signal quality based on the drive signal.

An apparatus for dynamically adjusting clock signal quality based on an operating mode for power savings is also disclosed. The apparatus includes means for generating a clock signal. The apparatus also includes means for providing a drive signal based on an operating mode. The apparatus further includes means for adjusts a clock signal quality based on the drive signal.

### BRIEF DESCRIPTION OF THE DRAWINGS

FIG. 1 is a block diagram illustrating one configuration of clock buffer circuitry that may be dynamically adjusted for power conservation;

FIG. 2 is a flow diagram illustrating one configuration of a method for dynamically adjusting clock buffer circuitry for power conservation;

FIG. 3 is a flow diagram illustrating a more specific configuration of a method for dynamically adjusting clock buffer circuitry for power conservation;

FIG. 4 is a block diagram illustrating a more specific configuration of clock buffer circuitry that may be dynamically adjusted for power conservation;

FIG. 5 is a diagram illustrating one example of dynamically adjusting clock buffer circuitry for power conservation;

FIG. 6 is a block diagram illustrating one example of clock buffer circuitry that may be dynamically adjusted for power conservation;

FIG. 7 is a block diagram illustrating another example of clock buffer circuitry that may be dynamically adjusted for power conservation;

FIG. 8 is a block diagram illustrating one configuration of power management circuitry;

FIG. 9 is a block diagram illustrating one configuration of a wireless communication device in which systems and methods for dynamically adjusting clock buffer circuitry for power conservation may be implemented;

FIG. 10 illustrates various components that may be utilized in an electronic device; and

FIG. 11 illustrates certain components that may be included within a wireless communication device.

### DETAILED DESCRIPTION

The systems and methods disclosed herein may be applied to a variety of electronic devices. Examples of electronic devices include voice recorders, video cameras, audio players (e.g., Moving Picture Experts Group-1 (MPEG-1) or MPEG-2 Audio Layer 3 (MP3) players), video players, audio recorders, desktop computers, laptop computers, personal digital assistants (PDAs), gaming systems, tablet devices, appliances, etc. One kind of electronic device is a communication device, which may communicate with another device. Examples of communication devices include telephones, laptop computers, desktop computers, cellular phones, smartphones, wireless or wired modems, e-readers, tablet devices, gaming systems, cellular telephone base stations or nodes, access points, wireless gateways and wireless routers.

An electronic device or communication device may operate in accordance with certain industry standards, such as International Telecommunication Union (ITU) standards and/or Institute of Electrical and Electronics Engineers (IEEE) standards (e.g., Wireless Fidelity or “Wi-Fi” standards such as 802.11a, 802.11b, 802.11g, 802.11n and/or 802.11ac). Other examples of standards that a communication device may comply with include IEEE 802.16 (e.g., Worldwide Interoperability for Microwave Access or “WiMAX”), Third Generation Partnership Project (3GPP), 3GPP Long Term Evolution (LTE), Global System for Mobile Telecommunications (GSM) and others (where a communication device may be referred to as a User Equipment (UE), Node B, evolved Node B (eNB), mobile device, mobile station, subscriber station, remote station, access terminal, mobile terminal, terminal, user terminal, subscriber unit, etc., for example). While some of the systems and methods disclosed herein may be described in terms of one or more standards, this should not limit the scope of the disclosure, as the systems and methods may be applicable to many systems and/or standards.

It should be noted that some communication devices may communicate wirelessly and/or may communicate using a wired connection or link. For example, some communication devices may communicate with other devices using an Ethernet protocol. The systems and methods disclosed herein may be applied to communication devices that communicate wirelessly and/or that communicate using a wired connection or link. In one configuration, the systems and methods disclosed herein may be applied to a communication device that communicates with another device using a satellite.

Some configurations of the systems and methods disclosed herein allow dynamic clock buffer power conservation or savings (e.g., optimization) based on modes of operation. For example, clock buffers in a power management integrated circuit (PMIC) may have several modes of operation that vary in power consumption and performance. Leaving the buffers set at a fixed high-power setting can result in wasted power for modes that do not have stringent phase noise (PN), jitter and other clock signal quality requirements. Rather, lower power modes of operation for the clock buffers may be used for such modes. The systems and methods disclosed herein may help solve the wasted power problem by dynamically changing the power settings of the buffers (analog and digital) based on the requirements of the loads. This may result in power savings at a battery, for instance.

The systems and methods disclosed herein may provide power reduction techniques. For example, clock buffers may be dynamically configured according to different power modes based on the load requirements in different operating modes (e.g., modes of operation). This is in contrast to a traditional approach. Traditionally, clock buffers (e.g., PMIC clock buffers) are left in a static configuration for all modes of operation. However, some modes can tolerate worse performance and could be put in a lower power consuming mode.

The systems and methods disclosed herein may reduce (e.g., optimize) power consumption. As dictated by concurrency requirements, for example, sensitive loads that need a cleaner clock may use higher power modes. However, loads that can handle a noisier clock may use the lower power modes. This may result in power savings. Such power savings may be particularly useful for devices that use a battery to provide power. Thus, the systems and methods disclosed herein may provide power savings due to configurable clock buffers. The clock buffers may be configured based on a load's clock signal quality requirements. The systems and methods disclosed herein may be applied to a wide variety of devices, such as electronic circuitry, computing devices, wireless communication devices, etc.

It should be noted that the terms “couple,” “coupling,” “coupled” or other variations of the word couple as used herein may indicate either an indirect connection or a direct connection. For example, if a first component is “coupled” to a second component, the first component may be either indirectly connected (e.g., through another component) to the second component or directly connected to the second component.

It should be noted that as used herein, designating a component, element or entity (e.g., transistor, capacitor, resistor, power supply, circuit, etc.) as a “first,” “second,” “third” or “fourth” component may be arbitrary and is used to distinguish components for explanatory clarity. It should also be noted that labels used to designate a “second,” “third” or “fourth,” etc., do not necessarily imply that elements using preceding labels “first,” “second” or “third,” etc., are included or used. For example, simply because an element or component is labeled a “third” component does not necessarily imply that “first” and “second” elements or components exist or are used. In other words, the numerical labels (e.g., first, second, third, fourth, etc.) are labels used for ease in explanation and do not necessarily imply a particular number of elements or a particular structure. Thus, the components may be labeled or numbered in any manner.

It should be noted that the term “circuitry” as used herein may denote one or more circuit components (e.g., resistors, capacitors, inductors, transistors, etc.). Circuitry may additionally or alternatively use other components, such as processing and/or memory cells, etc. Thus, “circuitry” may be implemented in hardware, software or a combination of both. Examples of circuitry include integrated circuits (ICs), application specific integrated circuits (ASICs), processors, memory cells, registers, amplifiers, etc.

Various configurations are now described with reference to the Figures, where like reference numbers may indicate functionally similar elements. The systems and methods as generally described and illustrated in the Figures herein could be arranged and designed in a wide variety of different configurations. Thus, the following more detailed description of several configurations, as represented in the Figures, is not intended to limit scope, as claimed, but is merely representative of the systems and methods.

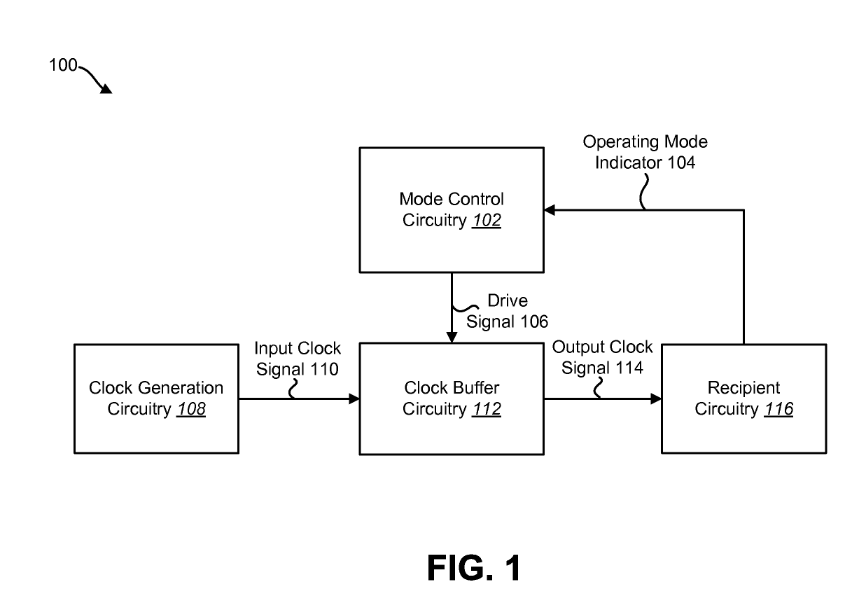

FIG. 1 is a block diagram illustrating one configuration of clock buffer circuitry 112 that may be dynamically adjusted for power conservation. For example, FIG. 1 illustrates circuitry 100 configured for dynamically adjusting clock signal quality based on an operating mode for power savings. The circuitry 100 may include clock generation circuitry 108 (that may or may not include a crystal, for example), mode control circuitry 102 and/or clock buffer circuitry 112. In some configurations, the circuitry 100 may include recipient circuitry 116. The clock buffer circuitry 112 may be coupled to the mode control circuitry 102, the clock generation circuitry 108 and/or the recipient circuitry 116. The clock generation circuitry 108 may generate an input clock signal 110. For example, the clock generation circuitry 108 may comprise a crystal and crystal oscillator circuitry used to generate the input clock signal 110. In some configurations, the clock generation circuitry 108 may include components used to compensate for variations in the input clock signal 110. The input clock signal 110 may include variations and other impairments. For example, the input clock signal 110 may not have adequate peak-to-peak amplitude for some applications and/or may be subject to phase noise, jitter, frequency drift and/or temperature variation.

The clock buffer circuitry 112 may be used to improve one or more aspects of the input clock signal 110. For example, the clock buffer circuitry 112 may amplify the input clock signal 110, may filter the input clock signal 110 and/or may convert the input clock signal 110 to a digital (e.g., square wave) signal. Additionally or alternatively, the clock buffer circuitry 112 may compensate for phase noise, frequency drift and/or temperature variation in the input clock signal 110.

The clock buffer circuitry 112 may operate based on a drive signal 106. For example, the clock buffer circuitry 112 may modify the input clock signal 110 to produce an output clock signal 114 based on a drive signal 106 strength. For instance, the clock buffer circuitry 112 may provide a “cleaner” or higher quality output clock signal 114 with increased drive signal 106 strength. A “cleaner” or higher quality output clock signal 114 may exhibit reduced phase noise, temperature variation, frequency drift and/or may provide a more accurate (e.g., desirable for the recipient circuitry 116) peak-to-peak amplitude. However, with decreased drive signal 106 strength, the clock buffer circuitry 112 may provide an output clock signal 114 that exhibits increased phase noise, jitter, temperature variation, frequency drift and/or a less accurate (e.g., lower, increased variation in, less desirable, etc.) peak-to-peak amplitude.

In one configuration, an operating mode, a drive signal 106 (e.g., drive signal 106 strength) and an output clock signal 114 may be characterized in terms of a highest quality operating mode and one or more reduced quality operating modes. For example, the recipient circuitry 116 may operate according to a set of operating modes including at least one highest quality operating mode and one or more reduced quality operating modes. The highest quality operating mode of the recipient circuitry 116 may require an output clock signal 114 that satisfies the most stringent operating requirements of the recipient circuitry 116. For instance, the highest quality operating mode of the recipient circuitry 116 may require a particular peak-to-peak amplitude, less phase noise, less frequency drift, less jitter and/or less temperature variation of the output clock signal 114 to operate properly in the highest quality operating mode. In other words, the highest quality operating mode may require a higher quality output clock signal 114 compared to the one or more reduced quality operating modes in the set of operating modes. The highest quality operating mode may correspond to a highest drive signal 106 strength in a set of drive signal 106 strengths and to a highest output clock signal 114 quality in a set of output clock signal 114 qualities. It should be noted that the use of the term “highest” may not denote an absolute “highest possible,” but may denote a “highest in a set.” In one example, global positioning system (GPS) circuitry may require a high quality clock with low jitter and low frequency drift.

Hypothetically speaking, providing a reduced quality output clock signal 114 to a recipient circuitry 116 when in a highest quality operating mode may cause the recipient circuitry 116 to provide degraded functionality and/or to malfunction. In other words, a highest quality clock signal 114 (and hence, a highest drive signal 106 strength) may be required for the recipient circuitry 116 to operate properly while in a highest operating mode. It should be noted that the recipient circuitry 116 may still operate properly while in a reduced quality operating mode if a highest quality output clock signal 114 were provided. However, the recipient circuitry 116 may still function properly while in a reduced quality operating mode when provided with a reduced quality output clock signal 114. Providing the reduced quality output clock signal 114 instead of the highest quality output clock signal 114 may conserve power, for instance, since the drive signal 106 strength may be reduced.

A reduced quality operating mode may correspond to a reduced drive signal 106 strength and to a lower quality output clock signal 114 when respectively compared to the highest drive signal 106 strength and to a highest quality output clock signal 114. For example, a reduced quality operating mode may correspond to a reduced drive signal 106 strength compared to a highest drive signal 106 strength in a set. Furthermore, a reduced quality operating mode may correspond to a reduced output clock signal 114 quality compared to a highest output clock signal 106 quality in a set. For example, a reduced quality output clock signal 114 may exhibit increased phase noise, increased frequency drift, a lower peak-to-peak amplitude, etc. However, the reduced quality operating mode may provide a reduced quality output clock signal 114 that allows the recipient circuitry 116 to operate properly while providing power savings. In one example, modem circuitry may tolerate a low quality clock with slewed clock edges and some jitter.

In some configurations, the clock buffer circuitry 112 may provide multiple output clock signals 114. For example, the clock buffer circuitry 112 may provide different output clock signals 114 of the same or differing qualities. For instance, the clock buffer circuitry 112 may provide a low-quality output clock signal 114, a medium-quality output clock signal 114 and/or a high-quality output clock signal 114. The output clock signal(s) 114 may be provided to recipient circuitry 116. For example, a first output clock signal 114 may be provided to a first recipient circuitry 116 and a second output clock signal 114 may be provided to a second recipient circuitry 116.

The recipient circuitry 116 may use the output clock signal(s) 114 to perform one or more operations. Examples of recipient circuitry 116 include processors, global positioning system (GPS) circuitry, Bluetooth circuitry, a frequency modulation (FM) receiver chip, interface circuitry (e.g., ports, etc.), signal processing circuitry (e.g., radio frequency (RF) chips), communications circuitry (e.g., modulators, demodulators, encoders, etc.) and/or timers, etc. For instance, the recipient circuitry 116 may use the output clock signal 114 to execute instructions, receive a signal, transmit a signal, encode a signal, decode a signal, modulate a signal, demodulate a signal, track time and/or coordinate communications, etc.

In some configurations, the recipient circuitry 116 may function according to differing operating modes. For example, the recipient circuitry 116 may require a particular quality of output clock signal 114 while in a first operating mode (e.g., highest quality operating mode), but may not require the same quality of output clock signal 114 in a second operating mode (e.g., reduced quality operating mode). For instance, an RF chip may require a high quality output clock signal 114 while actively transmitting and receiving payload data, but may be able to tolerate a lower quality output clock signal 114 (with increased phase noise, frequency drift, etc., for example) while not transmitting or receiving payload data.

In one configuration, the recipient circuitry 116 may send an operating mode indicator 104 to the mode control circuitry 102. In other words, the recipient circuitry 116 may control changes (e.g., transitions) in an operating mode by providing the operating mode indicator 104. The operating mode indicator 104 may explicitly or implicitly indicate an operating mode for the recipient circuitry 116. The mode control circuitry 102 may control the drive signal 106 based on the operating mode indicator 104. In one configuration, the mode control circuitry 102 may include mode mapping circuitry and one or more registers. The mode mapping circuitry may map the operating mode indicator 104 to register bits that control drive signal 106 strength. For example, if the operating mode indicator 104 indicates that a high quality output clock signal 114 is required, the mode mapping circuitry may produce a set of corresponding register bits. The register bits may configure one or more registers to increase the drive signal 106 strength in order to cause the clock buffer circuitry 112 to provide a high quality output clock signal 114. The mode control circuitry 102 may similarly decrease the drive signal 106 strength when an operating mode indicator 104 indicates that a lower quality output clock signal 114 is sufficient.

In one example, if an RF chip (e.g., recipient circuitry 116) is about to enter an active operating mode, the RF chip may send an operating mode indicator 104 to the mode control circuitry 102 indicating an operating mode that requires a high quality output clock signal 114. The mode control circuitry 102 may increase the drive signal 106 strength, thereby causing the clock buffer circuitry 112 to output a high quality output clock signal 114. Continuing the example, if the RF chip (e.g., recipient circuitry 116) is about to enter a passive mode, the RF chip may send an operating mode indicator 104 to the mode control circuitry 102 indicating an operating mode that does not require a high quality output clock signal 114 (when the RF chip or recipient circuitry 116 can tolerate a lower quality output clock signal 114). Accordingly, the mode control circuitry 102 may reduce the drive signal 106 strength, thereby causing the clock buffer circuitry 112 to provide a lower quality output clock signal 114 to the RF chip. Electrical power may be conserved by reducing the drive signal 106 strength while in operating modes that do not require a high quality output clock signal 114. Thus, the clock buffer circuitry 112 and the recipient circuitry 116 may operate more efficiently. This may be particularly useful in a configuration where the mode control circuitry 102, clock buffer circuitry 112 and/or one or more recipient circuitries 116 are included in an electronic device powered by a battery.

In some configurations, multiple recipient circuitries 116 may be used in accordance with the systems and methods disclosed herein. For example, a first recipient circuitry 116 may require a high quality output clock signal 114 during an active operating mode, but not during a passive operating mode. A second recipient circuitry 116 may only require a lower quality output clock signal 114 (with increased phase noise, frequency drift, etc.). While in an active operating mode, the mode control circuitry 102 may increase drive signal 106 strength to provide a high quality output clock signal 114. This may come as a result of an active operating mode indicator 104 provided by the first recipient circuitry 116. The high quality output clock signal 114 may be provided to both the first recipient circuitry 116 and the second recipient circuitry 116. However, if the operating mode indicator 104 indicates that a lower quality output clock signal 114 is sufficient, the mode control circuitry 102 may lower the drive signal 106 strength, causing the clock buffer circuitry 112 to provide a lower quality output clock signal 114. This may reduce power consumption.

While in a high quality operating mode, some recipient circuitry 116 may require high quality output clock signals 114. In one configuration, global positioning system (GPS) circuitry (e.g., recipient circuitry 116) and radio frequency (RF) circuitry (e.g., recipient circuitry 116) may require high quality output clock signals 114 while in a high quality operating mode. On the other hand, some recipient circuitry 116 may be able to tolerate low quality output clock signals 114. In one configuration, modem circuitry (e.g., recipient circuitry 116) may be able to tolerate a low quality output clock signal 114. It should be noted, however, that GPS circuitry, RF circuitry and modem circuitry may have different requirements and different tolerances. Furthermore, the differing requirements and differing tolerances may vary according to operating mode (e.g., high quality operating mode, medium quality operating mode, low quality operating mode, etc.).

In some configurations, multiple different operating modes may be used. For example, one or more recipient circuitries 116 may require a range of output clock signal 114 qualities based on multiple operating modes. One or more recipient circuitries 116 may thus provide multiple operating mode indicators 104. The mode control circuitry 102 may accordingly provide multiple drive signal 106 strengths. Furthermore, the clock buffer circuitry 112 may provide multiple output clock signal 114 qualities. Additionally or alternatively, the mode control circuitry 102 may provide multiple drive signals 106 to different clock buffers included in the clock buffer circuitry 112, thereby allowing multiple output clock signals 114 of the same or differing qualities.

In some configurations, one or more operating mode indicators 104 may additionally or alternatively be provided from circuitry other than the recipient circuitry 116. For example, controller circuitry (not illustrated in FIG. 1) may dictate when an operating mode may change in addition to or alternatively from the recipient circuitry 116. In such a case, the controller circuitry may provide one or more operating mode indicators 104 to the mode control circuitry 102. Examples of controller circuitry include processors, computer-program products, integrated circuits (ICs), modems, etc. In one configuration, controller circuitry may control one or more aspects of operation of the clock generation circuitry, the mode control circuitry 102, the clock buffer circuitry 112 and/or the recipient circuitry 116. Thus, the controller circuitry may control changes (e.g., transitions) in an operating mode by providing the operating mode indicator 104. This may be in addition to or alternatively from control provided by the recipient circuitry 116 for changes (e.g., transitions) in the operating mode.

It should be noted that the output clock signal 114 quality may be continually adjusted based on an operating mode indicator 104. For example, operating modes (e.g., required output clock signal 114 quality) may vary with time, which may be reflected by the operating mode indicator 104.

It should be noted that drive signal 106 may be implemented as a current, voltage or data. Thus, for example, the drive signal 106 strength may be increased or decreased by respectively increasing or decreasing an electrical current, by increasing or decreasing a voltage and/or by sending data (e.g., a message, indicator, etc.).

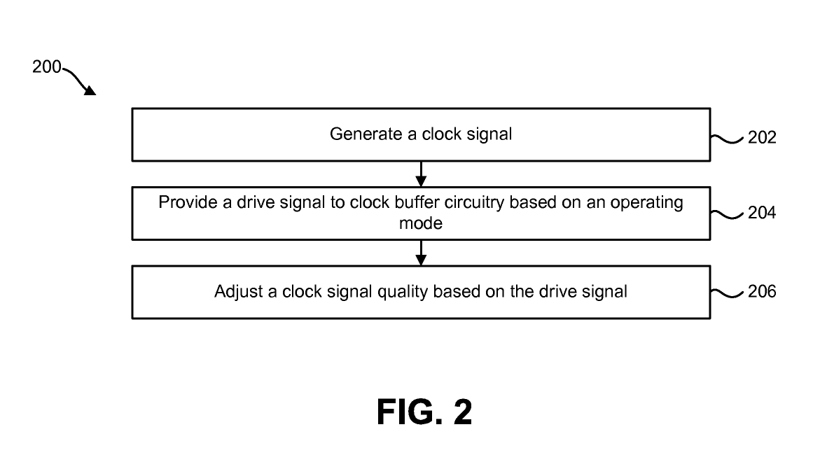

FIG. 2 is a flow diagram illustrating one configuration of a method 200 for dynamically adjusting clock buffer circuitry for power conservation. Clock generation circuitry 108 may generate 202 a clock signal (e.g., input clock signal 110). For example, the clock generation circuitry 108 may include a crystal and crystal oscillator circuitry for generating the clock signal 110.

Mode control circuitry 102 may provide 204 a drive signal 106 to clock buffer circuitry 112 based on an operating mode. For example, the mode control circuitry 102 may receive an operating mode indicator 104 that indicates an operating mode of recipient circuitry 116. The mode control circuitry 102 may control a drive signal 106 strength based on the operating mode indicator 104. For example, the mode control circuitry 102 may set the drive signal 106 strength that will produce a clock signal 114 quality that corresponds to the recipient circuitry 116 operating mode.

The clock buffer circuitry 112 may adjust 206 a clock signal 114 quality based on the drive signal 106. In one configuration, the clock signal 114 quality may be adjusted such that it is sufficient to adequately support the recipient circuitry 116 in the current operating mode. For example, if the recipient circuitry 116 requires increased clock signal 114 quality for the current operating mode, the clock buffer circuitry 112 may increase the clock signal 114 quality according to the drive signal 106 such that the recipient circuitry 116 may function properly in the current operating mode. However, if the recipient circuitry 116 can tolerate a lower quality output clock 114 signal in the current operating mode, the clock buffer circuitry 112 may reduce the clock signal 114 quality according to the drive signal 106 in order to conserve energy or power.

In one configuration, a clock signal 114 quality that is sufficient to support proper operation of the recipient circuitry 116 in an operating mode may be expressed with a margin or tolerance of operation. For example, each operating mode may specify an amount of frequency variation, an amount of tolerable jitter, an amount of tolerable phase noise, etc. For instance, a highest quality operating mode for recipient circuitry 116 may specify a tolerance that is less than or equal to ±10 parts per million (ppm) for frequency (e.g., frequency drift). Reduced quality operating modes may allow a larger tolerance for frequency (e.g., frequency drift), for example.

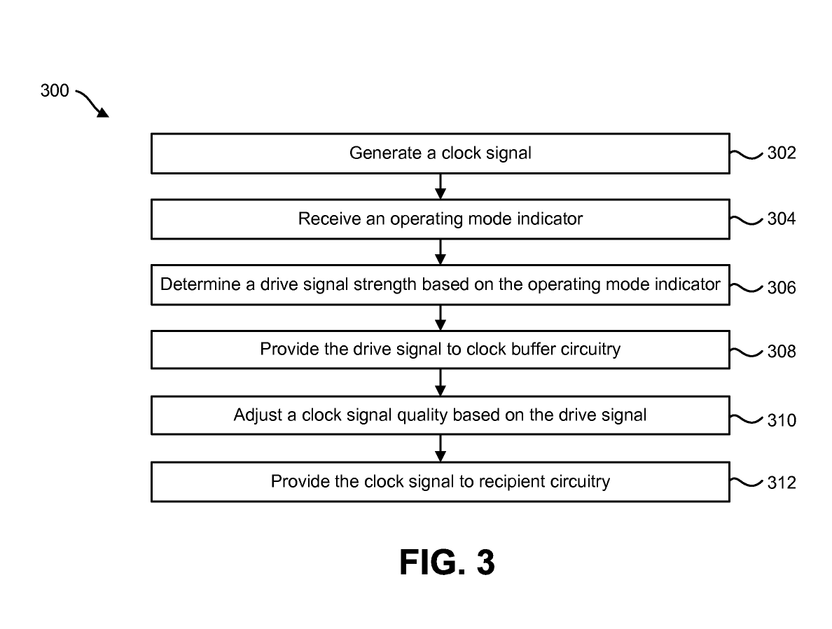

FIG. 3 is a flow diagram illustrating a more specific configuration of a method 300 for dynamically adjusting clock buffer circuitry for power conservation. Clock generation circuitry 108 may generate 302 a clock signal (e.g., input clock signal 110). For example, the clock generation circuitry 108 may include a crystal and crystal oscillator circuitry for generating the clock signal 110.

Mode control circuitry 102 may receive 304 an operating mode indicator 104. For example, the mode control circuitry 102 may receive 304 a message, signal, bit(s), etc., that may indicate a current or anticipated operating mode of the recipient circuitry 116. The operating mode indicator 104 may be an explicit or implicit indicator. For instance, the recipient circuitry 116 or controller circuitry may send an explicit indicator that may be received 304 by the mode control circuitry 102 that corresponds to a particular operating mode of the recipient circuitry 116. Additionally or alternatively, the mode control circuitry 102 may receive an implicit indicator (e.g., an RF chip begins communication procedures) that indicates a particular operating mode.

The mode control circuitry 102 may determine 306 a drive signal 106 strength based on the operating mode indicator 104. For example, the mode control circuitry 102 may determine 306 a drive signal 106 strength that is required to produce an adequate clock signal 114 quality sufficient for the operating mode of the recipient circuitry 116. This determination 306 may be made differently based on the configuration of the systems and methods used. In one configuration, the mode control circuitry 102 could use a look-up table to determine the drive signal 106 strength that corresponds to a particular operating mode (as given by the operating mode indicator 104, for example) of the recipient circuitry 116. In another configuration, the mode control circuitry 102 may include a multiplexer that produces register bits that correspond to a drive signal 106 strength required to produce a sufficient clock signal 114 quality to satisfy the recipient circuitry 116 in a current or anticipated operating mode.

Mode control circuitry 102 may provide 308 the drive signal 106 to clock buffer circuitry 112. For example, the mode control circuitry 102 may provide the drive signal 106 strength to the clock buffer circuitry 112 that will produce a clock signal 114 quality that corresponds to the recipient circuitry 116 operating mode.

The clock buffer circuitry 112 may adjust 310 a clock signal 114 quality based on the drive signal 106. In one configuration, the clock signal 114 quality may be adjusted such that it is sufficient to adequately support the recipient circuitry 116 in the current operating mode. For example, if the recipient circuitry 116 requires increased clock signal 114 quality for the current operating mode, the clock buffer circuitry 112 may increase the clock signal 114 quality according to the drive signal 106 such that the recipient circuitry 116 may function properly in the current operating mode. However, if the recipient circuitry 116 can tolerate a lower quality output clock 114 signal in the current operating mode, the clock buffer circuitry 112 may reduce the clock signal 114 quality according to the drive signal 106 in order to conserve energy or power.

The clock buffer circuitry 112 may provide 312 the clock signal 114 to the recipient circuitry 116. For example, the clock buffer circuitry 112 may provide 312 the clock signal 114 of the quality indicated by the operating mode indicator 104 to the corresponding recipient circuitry 116. In one configuration, the clock buffer circuitry 112 may provide 312 different clock signal 114 qualities and/or different clock signal 114 types (e.g., analog, digital) in accordance with the operating mode specified.

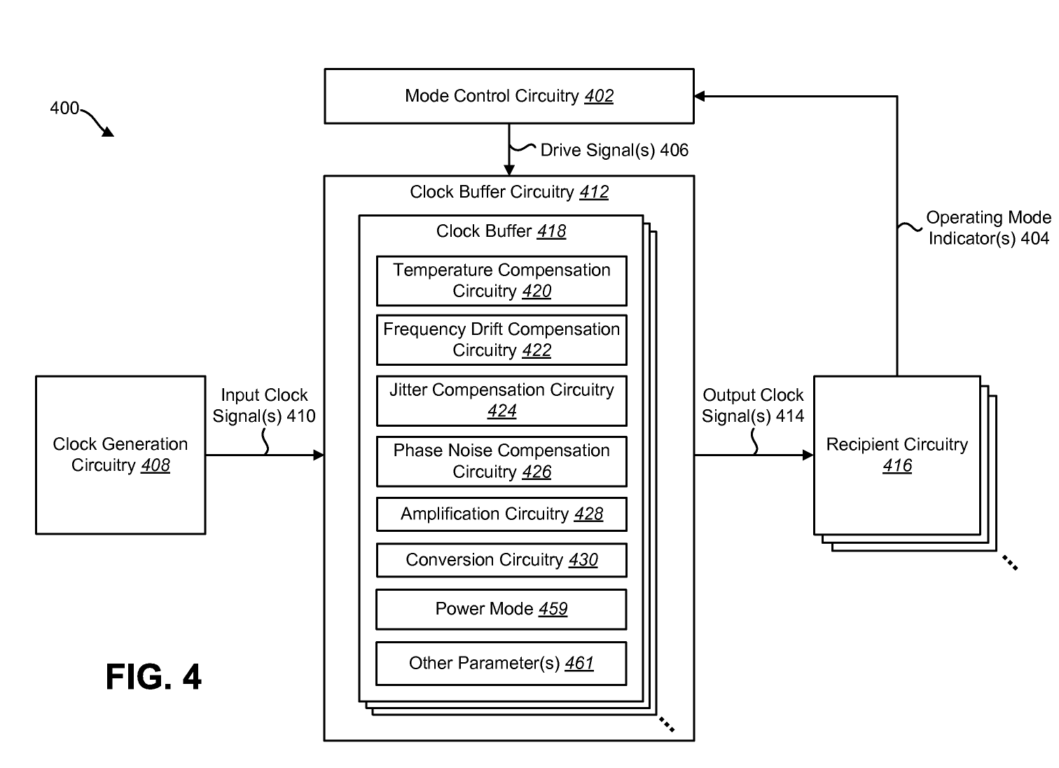

FIG. 4 is a block diagram illustrating a more specific configuration of clock buffer circuitry 412 that may be dynamically adjusted for power conservation. For example, FIG. 4 illustrates circuitry 400 configured for dynamically adjusting clock signal quality based on an operating mode for power savings. The clock buffer circuitry 412 may be coupled to mode control circuitry 402, clock generation circuitry 408 and/or one or more recipient circuitries 416. The clock generation circuitry 408 may generate one or more input clock signals 410. For example, the clock generation circuitry 408 may comprise a crystal and crystal oscillator circuitry used to generate the input clock signal(s) 410. In some configurations, the clock generation circuitry 408 may include components used to compensate for variations in the input clock signal 410. The input clock signal 410 may include variations and other impairments. For example, the input clock signal 410 may not have adequate peak-to-peak amplitude for some applications and/or may be subject to phase noise, jitter, frequency drift and/or temperature variation.

The clock buffer circuitry 412 may be used to improve one or more aspects of the input clock signal(s) 410. The clock buffer circuitry 412 may include one or more clock buffers 418. Each of the one or more clock buffers 418 may include one or more of temperature compensation circuitry 420, frequency drift compensation circuitry 422, jitter compensation circuitry 424, phase noise compensation circuitry 426, amplification circuitry 428, conversion circuitry 430 and other circuitry used to improve the characteristics of the input clock signal(s) 410. The temperature compensation circuitry 420 may compensate for temperature variation in the input clock signal(s) 410. The frequency drift compensation circuitry 422 may compensate for variations in the frequency of the input clock signal(s) 410. The jitter compensation circuitry 424 may compensate for variations in time (e.g., phase), frequency and/or amplitude of the input clock signal(s) 410. The phase noise compensation circuitry 426 may compensate for variations in phase of the input clock signal(s) 410. The amplification circuitry 428 may amplify the input clock signal(s) 410. The conversion circuitry 430 may convert one or more of the input clock signals 410 to a digital (e.g., square wave) signal. Other circuitry (e.g., filtering circuitry) or circuitries may be used to additionally or alternatively enhance the input clock signal(s) 410. For example, other circuitries in the clock buffer(s) 418 may be used to improve a slew rate and/or reduce distortion in the output clock signal(s) 414.

Additionally or alternatively, one or more clock buffers 418 may be configured according to one or more power modes 459 and/or according to one or more other parameters 461. For example, a power mode 459 may allow a clock buffer 418 to be configured to operate with a specified amount of power consumption. For instance, a number of power modes 459 may each configure a clock buffer 418 to consume a given current (e.g., an average number of amperes) while in operation. The configured power mode 459 may effect the functioning of one or more of the temperature compensation circuitry 420, frequency drift compensation circuitry 422, jitter compensation circuitry 424, phase noise compensation circuitry 426, amplification circuitry 428, conversion circuitry 430 and other circuitry or circuitries. For example, a reduced power mode (corresponding to a reduced quality operating mode, for instance) may consume less power at the expense of reduced output clock signal 414 quality. However, a highest (or high) power mode (corresponding to a highest (or high) power mode) may provide a higher quality output clock signal 414 at the expense of greater power consumption. It should be noted that multiple power modes 459 may be used that offer a range of output clock signal 414 qualities (e.g., low, medium, high, etc.) in trade for power consumption. In one configuration, the power mode 459 may be set or configured based on one or more drive signals 406 (e.g., current, voltage or data).

The one or more clock buffers 418 may additionally or alternatively be configured to operate in accordance with one or more other parameters 461. The one or more other parameters 461 may be adjustable to control the performance of the clock buffer(s) 418 (e.g., the output clock signal 414 quality). For example, one other parameter 461 may be used to adjust a slew rate of one or more output clock signals 414. Another parameter 461 may be used to adjust distortion in the output clock signal(s) 414. One or more other parameters may effect the functioning of one or more of the temperature compensation circuitry 420, frequency drift compensation circuitry 422, jitter compensation circuitry 424, phase noise compensation circuitry 426, amplification circuitry 428, conversion circuitry 430 and other circuitry or circuitries. Changing the other parameter(s) 461 may effect power consumption in trade for output clock signal 414 quality. In general, reducing an output clock signal 414 quality based on one or more other parameters 461 may reduce power consumption. Conversely, increasing an output clock signal 414 quality based on one or more other parameters 461 may increase power consumption. In one configuration, the other parameter(s) 461 may be set or configured based on one or more drive signals 406 (e.g., current, voltage or data).

It should be noted that as the one or more drive signals 406 are reduced, the performance of the one or more clock buffers 418 may accordingly be reduced. For example, reducing a drive signal (e.g., reducing a current, reducing a voltage, changing a data message, etc.) 406 may reduce the capability of a clock buffer 418 to improve one or more characteristics of the input clock signal 410. For example, in a reduced quality operating mode, the performance of one or more of the circuitries 420, 422, 424, 426, 428, 430 may be lessened or even disabled. In one configuration, a drive signal 406 may be reduced to the point that the output clock signal 414 is substantially equivalent to the input clock signal 410. It should be noted however, that a range or many different levels of operation of the one or more circuitries 420, 422, 424, 426, 428, 430 may be achieved. For instance, only a selection of the circuitries 420, 422, 424, 426, 428, 430 may be disabled when a drive signal 406 is reduced. Additionally or alternatively, the performance of one or more of the circuitries 420, 422, 424, 426, 428, 430 may be reduced with the reduced drive signal 406. It should be noted that a clock buffer 418 need not include all of the circuitries illustrated 420, 422, 424, 426, 428, 430 or indeed, any. Rather, a clock buffer 418 may include one or more of the circuitries 420, 422, 424, 426, 428, 430 illustrated or some other circuitry that improves a characteristic of the input clock signal 410.

The clock buffer circuitry 412 (e.g., the one or more clock buffers 418) may operate based on one or more drive signals 406. For example, the clock buffer circuitry 412 may modify one or more of the input clock signals 410 to produce one or more output clock signals 414 based on the strength of the one or more drive signals 406. For instance, a clock buffer 418 may provide a “cleaner” or higher quality output clock signal 414 with increased drive signal 406 strength. A “cleaner” or higher quality output clock signal 414 may exhibit reduced phase noise, temperature variation, frequency drift, jitter and/or may provide a more accurate (e.g., desirable for the recipient circuitry 416) peak-to-peak amplitude. However, with decreased drive signal 406 strength, a clock buffer 418 may provide an output clock signal 414 that exhibits increased phase noise, jitter, temperature variation, frequency drift, jitter and/or a less accurate (e.g., lower, increased variation in, less desirable, etc.) peak-to-peak amplitude.

In some configurations, the clock buffer circuitry 412 may provide multiple output clock signals 414. For example, the clock buffer circuitry 412 may provide different output clock signals 414 of the same or differing qualities. For instance, the clock buffer circuitry 412 may provide a low-quality output clock signal 414, a medium-quality output clock signal 414 and/or a high-quality output clock signal 414. The output clock signal(s) 414 may be provided to one or more recipient circuitries 416. For example, a first output clock signal 414 may be provided to a first recipient circuitry 416 and a second output clock signal 414 may be provided to a second recipient circuitry 416.

The one or more recipient circuitries 416 may use the output clock signal(s) 414 to perform one or more operations. Examples of recipient circuitries 416 include processors, global positioning system (GPS) circuitry, Bluetooth circuitry, a frequency modulation (FM) receiver chip, interface circuitry (e.g., ports, etc.), signal processing circuitry (e.g., radio frequency (RF) chips), communications circuitry (e.g., modulators, demodulators, encoders, etc.) and/or timers, etc. For instance, the one or more recipient circuitries 416 may use the output clock signal(s) 414 to execute instructions, receive a signal, transmit a signal, encode a signal, decode a signal, modulate a signal, demodulate a signal, track time and/or coordinate communications, etc.

In some configurations, the one or more recipient circuitries 416 may function according to differing operating modes. For example, one recipient circuitry 416 may require a particular quality of output clock signal 414 while in a first operating mode (e.g., highest quality operating mode), but may not require the same quality of output clock signal 414 in a second operating mode (e.g., reduced quality operating mode). For instance, an RF chip may require a high quality output clock signal 414 while in an active operating mode (e.g., while transmitting and receiving payload data), but may be able to tolerate a lower quality output clock signal 414 (with increased phase noise, frequency drift, etc., for example) while in a passive operating mode (e.g., while not transmitting or receiving payload data).

In one configuration, one or more of the one or more recipient circuitries 416 may send one or more operating mode indicators 404 to the mode control circuitry 402. An operating mode indicator 404 may explicitly or implicitly indicate an operating mode for one or more recipient circuitries 416. The mode control circuitry 402 may control the one or more drive signals 406 based on the operating mode indicator 404. In one configuration, the mode control circuitry 402 may include mode mapping circuitry and one or more registers. The mode mapping circuitry may map the one or more operating mode indicators 404 to register bits that control the strength of the one or more drive signals 406. For example, if an operating mode indicator 404 indicates that a high quality output clock signal 414 is required by a recipient circuitry 416, the mode mapping circuitry may produce a set of corresponding register bits. The register bits may configure one or more registers to increase the strength of a drive signal 406 in order to cause a clock buffer 418 to provide a high quality output clock signal 414 to the recipient circuitry 416. The mode control circuitry 402 may similarly decrease the strength of a drive signal 406 when an operating mode indicator 404 indicates that a lower quality output clock signal 414 is sufficient for an operating mode of the recipient circuitry 416.

In one example, if an RF chip (e.g., a recipient circuitry 416) is about to enter an active operating mode, the RF chip may send an operating mode indicator 404 to the mode control circuitry 402 indicating an operating mode that requires a high quality output clock signal 414. The mode control circuitry 402 may increase a drive signal 406 strength, thereby causing a clock buffer 418 to output a high quality output clock signal 414. Continuing the example, if the RF chip (e.g., recipient circuitry 416) is about to enter a passive mode, the RF chip may send an operating mode indicator 404 to the mode control circuitry 402 indicating an operating mode that does not require a high quality output clock signal 414 (when the RF chip or recipient circuitry 416 can tolerate a lower quality output clock signal 414). Accordingly, the mode control circuitry 402 may reduce the drive signal 406 strength, thereby causing the clock buffer circuitry 412 to provide a lower quality output clock signal 414 to the RF chip. Electrical power may be conserved by reducing the drive signal 406 strength while in operating modes that do not require a high quality output clock signal 414. Thus, the clock buffer circuitry 412 and the recipient circuitry 416 may operate more efficiently.

In some configurations, multiple recipient circuitries 416 may be used in accordance with the systems and methods disclosed herein. For example, a first recipient circuitry 416 may require a high quality output clock signal 414 during an active operating mode, but not during a passive operating mode. A second recipient circuitry 416 may only require a lower quality output clock signal 414 (with increased phase noise, frequency drift, etc.). While in an active operating mode, the mode control circuitry 402 may increase drive signal 406 strength to provide a high quality output clock signal 414. This may come as a result of an active operating mode indicator 404 provided by the first recipient circuitry 416. The high quality output clock signal 414 may be provided to both the first recipient circuitry 416 and the second recipient circuitry 416. However, if the operating mode indicator 404 indicates that a lower quality output clock signal 414 is sufficient, the mode control circuitry 402 may lower the drive signal 406 strength, causing the clock buffer circuitry 412 to provide a lower quality output clock signal 414 for the first recipient circuitry 416 and the second recipient circuitry 416. This may reduce power consumption.

In some configurations, multiple different operating modes may be used. For example, one or more recipient circuitries 416 may require a range of output clock signal 414 qualities based on multiple operating modes. One or more recipient circuitries 416 may thus provide multiple operating mode indicators 404. The mode control circuitry 402 may accordingly provide multiple drive signal 406 strengths. Furthermore, the clock buffer circuitry 412 may provide multiple output clock signal 414 qualities. Additionally or alternatively, the mode control circuitry 402 may provide multiple drive signals 406 to different clock buffers 418 included in the clock buffer circuitry 412, thereby allowing multiple output clock signals 414 of the same or differing qualities.

In some configurations, one or more operating mode indicators 404 may additionally or alternatively be provided from circuitry other than the recipient circuitry 416. For example, controller circuitry (not illustrated in FIG. 4) may dictate when an operating mode may change in addition to or alternatively from the recipient circuitry 416. In such a case, the controller circuitry may provide one or more operating mode indicators 404 to the mode control circuitry 402.

It should be noted that a drive signal 406 may be implemented as a current or voltage. Thus, for example, a drive signal 406 strength may be increased or decreased by respectively increasing or decreasing an electrical current or voltage.

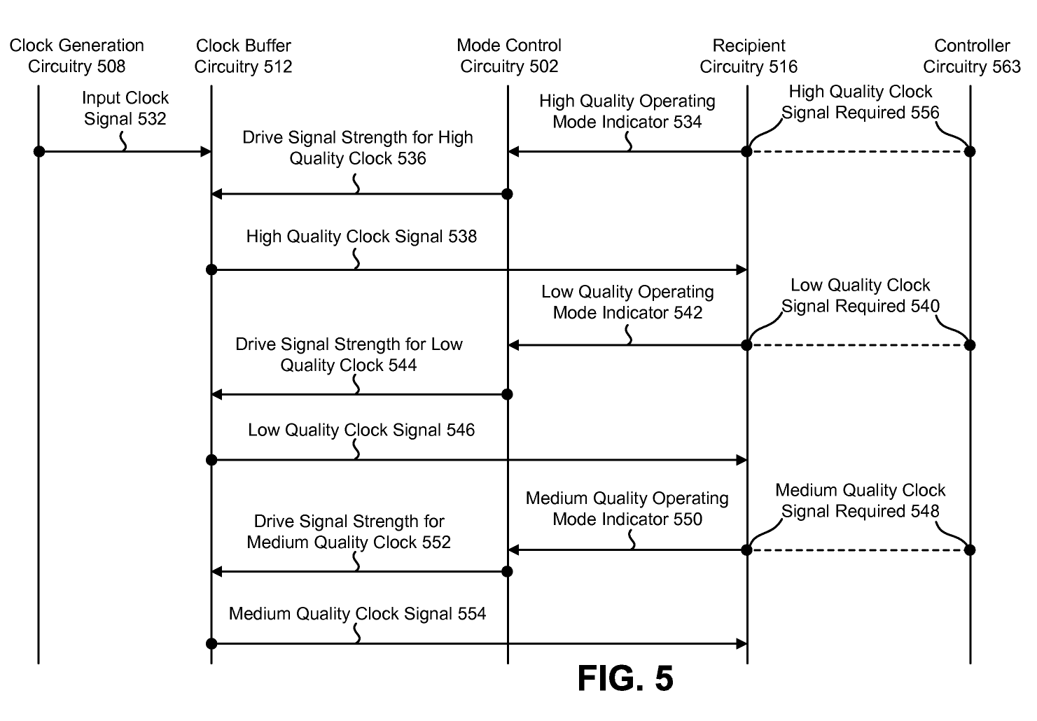

FIG. 5 is a diagram illustrating one example of dynamically adjusting clock buffer circuitry 512 for power conservation. In this example, clock generation circuitry 508 may provide an input clock signal 532 to the clock buffer circuitry 512. The recipient circuitry 516 (or controller circuitry 563) may determine that a high quality clock signal is required 556. For instance, the recipient circuitry 516 may be entering or anticipate entering a high quality operating mode (e.g., a highest quality operating mode in a set of operating modes). The recipient circuitry 516 (or controller circuitry 563) may provide (e.g., send) a high quality operating mode indicator 534 to mode control circuitry 502. In response, the mode control circuitry 502 may provide a drive signal strength for a high quality clock 536. The clock buffer circuitry 512 may provide a high quality clock signal 538 to the recipient circuitry 516.

In this example, the recipient circuitry 516 (or controller circuitry 563) then determines that only a low quality clock signal is required 540. For example, the recipient circuitry 516 determines that a low quality clock signal may be tolerated while in a low quality operating mode (e.g., a first reduced quality operating mode). Accordingly, the recipient circuitry 516 (or controller circuitry 563) provides (e.g., sends) a low quality operating mode indicator 542 to the mode control circuitry 502. In response, the mode control circuitry 502 provides a drive signal strength for a low quality clock 544. For example, the mode control circuitry 502 may reduce the drive signal strength to the clock buffer circuitry 512 in order to conserve power. Accordingly, the clock buffer circuitry 512 may provide a low quality clock signal 546 to the recipient circuitry 516.

Continuing the example, the recipient circuitry 516 (or controller circuitry 563) then determines that a medium quality clock signal is required 548. For example, the recipient circuitry 516 determines that a low quality clock signal is not sufficient for an anticipated “medium quality” operating mode (e.g., a second reduced quality operating mode). Accordingly, the recipient circuitry 516 (or controller circuitry 563) provides (e.g., sends) a medium quality operating mode indicator 550 to the mode control circuitry 502. In response, the mode control circuitry 502 provides a drive signal strength for a medium quality clock 552. For example, the mode control circuitry 502 may increase the drive signal strength to the clock buffer circuitry 512 in order to improve clock signal quality (from the low quality clock signal). Accordingly, the clock buffer circuitry 512 may provide a medium quality clock signal 554 to the recipient circuitry 516.

It should be noted that the controller circuitry 563 may additionally or alternatively control an operating mode. For example, the controller circuitry 563 may determine an operating mode and send an operating mode indicator to the mode control circuitry. For instance, controller circuitry 563 may determine that RF circuitry (e.g., recipient circuitry 516) will require a high quality clock signal to operate while transmitting and/or receiving data. In one configuration, this determination may be based on a signal sent from the RF circuitry (e.g., recipient circuitry 516) to the controller circuitry 563 and/or a signal received from another component (e.g., processor). Accordingly, the controller circuitry 563 may send a high quality operating mode indicator 534 to the mode control circuitry 502. This may be in addition to or alternatively from the RF circuitry (e.g., recipient circuitry 516).

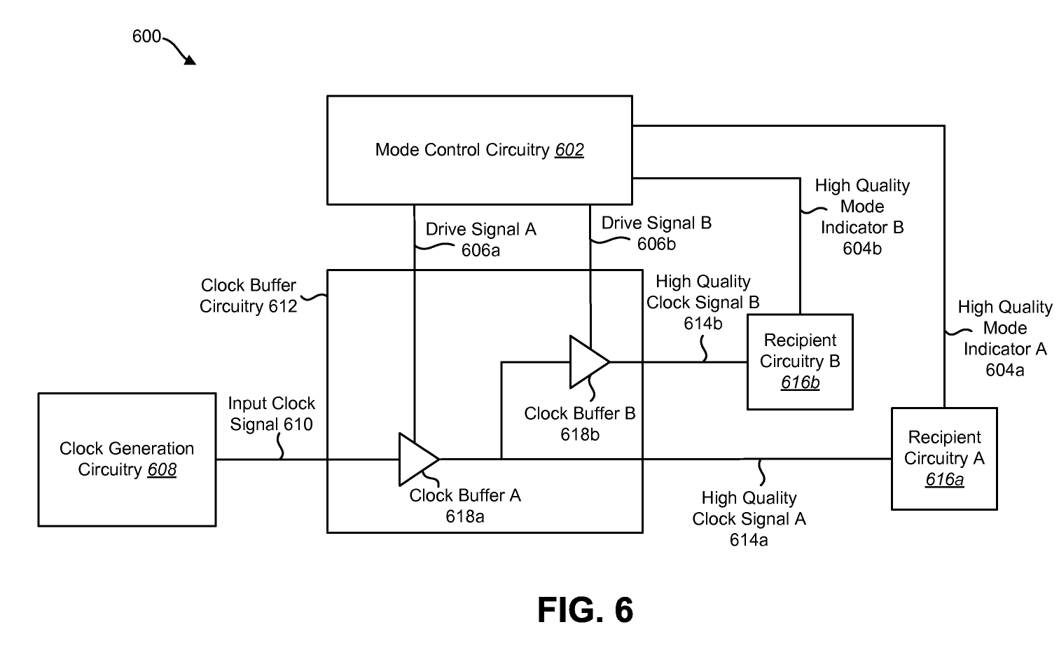

FIG. 6 is a block diagram illustrating one example of clock buffer circuitry 612 that may be dynamically adjusted for power conservation. For example, FIG. 6 illustrates circuitry 600 configured for dynamically adjusting clock signal quality based on an operating mode for power savings. The clock buffer circuitry 612 may be coupled to mode control circuitry 602, clock generation circuitry 608 and/or recipient circuitries 616a-b. The clock generation circuitry 608 may generate an input clock signal 610. For example, the clock generation circuitry 608 may comprise a crystal and crystal oscillator circuitry used to generate the input clock signal 610. The input clock signal 610 may not have adequate peak-to-peak amplitude for some applications and/or may be subject to phase noise, jitter, frequency drift and/or temperature variation.

The clock buffer circuitry 612 may be used to improve one or more aspects of the input clock signal 610. In the example illustrated in FIG. 6, the clock buffer circuitry 612 includes clock buffer A 618a and clock buffer B 618b. Clock buffer A 618a may amplify the input clock signal 610, compensate for phase noise, compensate for frequency drift and/or compensate for temperature variation in the input clock signal 610. Clock buffer B 618b may be coupled to the output of clock buffer A 618a and may amplify the signal provided by clock buffer A 618a, compensate for phase noise, compensate for frequency drift and/or compensate for temperature variation in the signal provided by clock buffer A 618a.

The recipient circuitries 616a-b may function according to differing operating modes. For example, the recipient circuitries 616a-b may require a particular quality of output clock signals 614a-b while in a first operating mode (e.g., a high quality operating mode), but may not require the same quality of the output clock signals 614a-b in a second operating mode (e.g., a reduced quality operating mode). For instance, an RF chip (e.g., recipient circuitry A 616a) may require high quality output clock signal A 614a while actively transmitting and receiving payload data, but may be able to tolerate a lower quality output clock signal (with increased phase noise, frequency drift, etc., for example) while not transmitting or receiving payload data.

When entering (or anticipating) the first operating mode, recipient circuitry A 616a and/or recipient circuitry B 616b may send operating mode indicators 604a-b to the mode control circuitry 602. The operating mode indicators 604a-b may indicate a high quality operating mode for the recipient circuitries 616a-b. The mode control circuitry 602 may control the drive signals 606a-b based on the operating mode indicators 604a-b. For example, the mode control circuitry 602 may provide drive signal 606a-b strengths that are sufficient to cause clock buffer A 618a and clock buffer B 618b to respectively output high quality clock signal A 614a and high quality clock signal B 614b.

In one example, if an RF chip (e.g., recipient circuitry A 616a) is about to enter an active operating mode, the RF chip may send high quality mode indicator A 604a to the mode control circuitry 602 indicating an operating mode that requires high quality output clock signal A 614a. The mode control circuitry 602 may increase the strength of drive signal A 606a, thereby causing clock buffer A 618a to output high quality output clock signal A 614a.

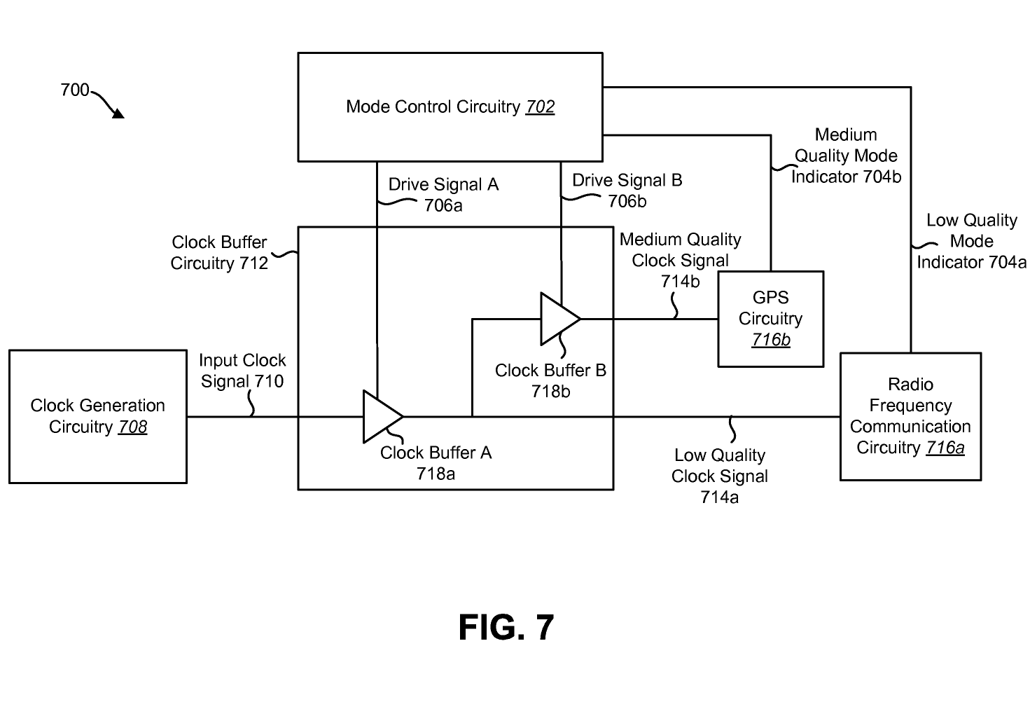

FIG. 7 is a block diagram illustrating another example of clock buffer circuitry 712 that may be dynamically adjusted for power conservation. For example, FIG. 7 illustrates circuitry 700 configured for dynamically adjusting clock signal quality based on an operating mode for power savings. For instance, the circuitry 702, 712, 716 illustrated in FIG. 7 may be the circuitry 602, 612, 616 illustrated in FIG. 6 that is entering (or anticipating) a reduced quality operating mode. The clock buffer circuitry 712 may be coupled to mode control circuitry 702, clock generation circuitry 708, radio frequency (RF) communication circuitry 716a and/or global positioning system (GPS) circuitry 716b. The clock generation circuitry 708 may generate an input clock signal 710. For example, the clock generation circuitry 708 may comprise a crystal and crystal oscillator circuitry used to generate the input clock signal 710. The input clock signal 710 may not have adequate peak-to-peak amplitude for some applications and/or may be subject to phase noise, jitter, frequency drift and/or temperature variation.

The clock buffer circuitry 712 may be used to improve one or more aspects of the input clock signal 710. In the example illustrated in FIG. 7, the clock buffer circuitry includes clock buffer A 718a and clock buffer B 718b. Clock buffer A 718a may amplify the input clock signal 710, compensate for phase noise, compensate for frequency drift and/or compensate for temperature variation in the input clock signal 710. Clock buffer B 718b may be coupled to the output of clock buffer A 718a and may amplify the signal provided by clock buffer A 718a, compensate for phase noise, compensate for frequency drift and/or compensate for temperature variation in the signal provided by clock buffer A 718a.

The RF communication circuitry 716a and the GPS circuitry 716b may function according to differing operating modes. For example, the GPS circuitry 716b may tolerate a medium quality clock signal 714b while in a second operating mode (e.g., reduced quality operating mode). Additionally, the RF communication circuitry 716a may tolerate a low quality clock signal 714a while in a second operating mode (e.g., reduced quality operating mode). For instance, RF communication circuitry 716a may tolerate a low quality clock signal 714a while not transmitting or receiving payload data. Additionally, GPS circuitry 716b may tolerate a medium quality clock signal 714b while in a second operating mode (e.g., reduced quality operating mode).

Alternatively, the GPS circuitry 716b may always require only a medium quality clock signal 714b. In that case, the strength of drive signal B 706b may be increased while clock buffer A 718a is providing a low quality clock signal 714a for the RF communication circuitry 716a in the second operating mode. Furthermore, the strength of drive signal B 706b may be decreased (or maintained) while clock buffer A 718a is providing a high quality clock signal for the RF communication circuitry 716a in the first operating mode.

When entering (or anticipating) the second operating mode, the RF communication circuitry 716a may send a low quality mode indicator 704a to the mode control circuitry 702. Additionally or alternatively, the GPS circuitry 716b may send a medium quality mode indicator 704b to the mode control circuitry 702.

The low quality operating mode indicator 704a and the medium quality operating mode indicator 704b may respectively indicate a low quality operating mode for the RF communication circuitry 716a and a medium quality operating mode for the GPS circuitry 716b. The mode control circuitry 702 may control the drive signals 706a-b based on the operating mode indicators 704a-b. For example, the mode control circuitry 702 may provide a (reduced) strength for drive signal A 706a in order to cause clock buffer A 718a to produce a low quality clock signal 714a. Additionally or alternatively, the mode control circuitry 702 may provide a (reduced) strength for drive signal B 706b in order to cause clock buffer B 718b to produce a medium quality clock signal 714b. Electrical power may be conserved by reducing the drive signal 706 strength while in operating modes that do not require a high quality output clock signal. Thus, the clock buffer circuitry 712 and the recipient circuitry 716 may operate more efficiently.

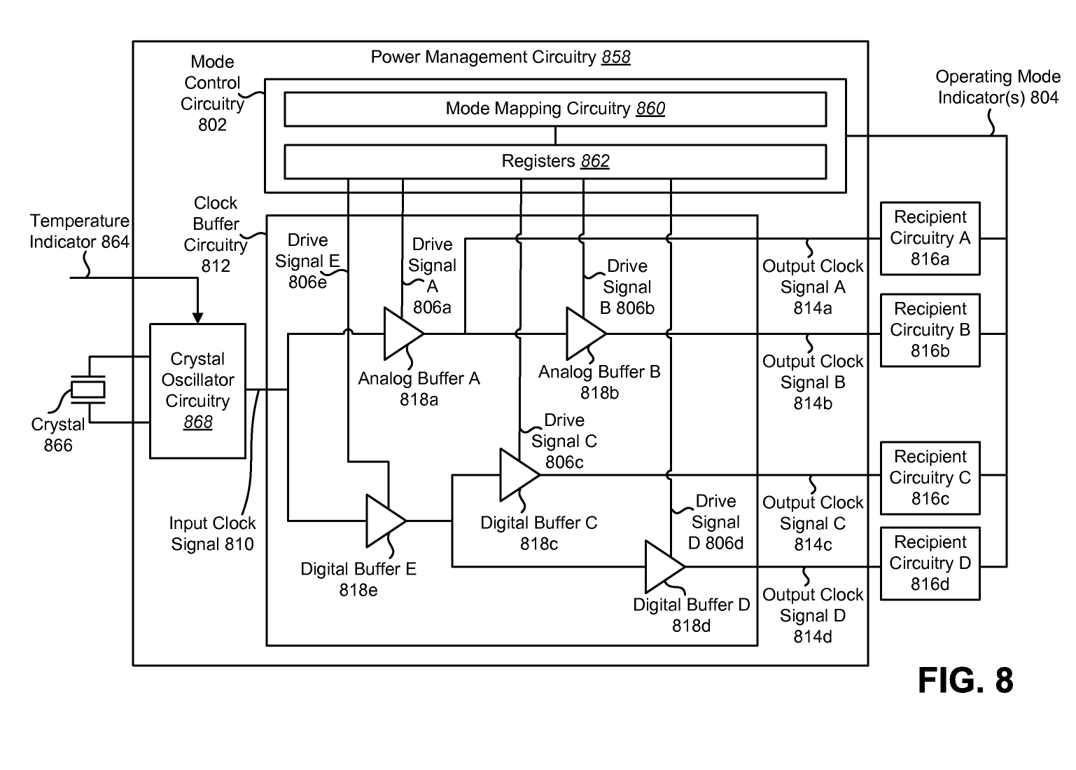

FIG. 8 is a block diagram illustrating one configuration of power management circuitry 858. One example of power management circuitry 858 is a power management integrated circuit (PMIC). In some configurations, the power management circuitry 858 may be included in an electronic device, such as an integrated circuit, a cellular phone, a smart phone, a computer, etc. In some configurations, the power management circuitry 858 may be one example of circuitry 100, 400, 600, 700 described above. The power management circuitry 858 may include mode control circuitry 802, crystal oscillator circuitry 868 and clock buffer circuitry 812. The clock buffer circuitry 812 may be dynamically adjusted for power conservation. The clock buffer circuitry 812 may be coupled to mode control circuitry 802, crystal oscillator circuitry 868 and/or recipient circuitries 816a-d. The crystal oscillator circuitry 868 may provide an input clock signal 810. For example, the crystal oscillator circuitry 868 may be coupled to a crystal 866 used to generate the input clock signal 810. For example, the crystal oscillator circuitry 868 may apply a voltage to the crystal 866 that causes the crystal 866 to provide an oscillating signal. In one configuration, the crystal 866 may oscillate at approximately 19.2 megahertz (MHz).

In some configurations, the crystal oscillator circuitry 868 may include components used to compensate for variations in the input clock signal 810. For example, the crystal oscillator circuitry 868 may use a temperature indicator 864 to compensate for temperature variations in the input clock signal 810. However, the input clock signal 810 may still vary according to temperature. The input clock signal 810 may include variations and other impairments. For example, the input clock signal 810 may not have adequate peak-to-peak amplitude for some applications and/or may be subject to phase noise, jitter, frequency drift and/or temperature variation.

The clock buffer circuitry 812 may be used to improve one or more aspects of the input clock signal 810. For example, the clock buffer circuitry 812 may amplify the input clock signal 810, may filter the input clock signal 810 and/or may convert the input clock signal 810 to a digital (e.g., square wave) signal. Additionally or alternatively, the clock buffer circuitry 812 may compensate for phase noise, frequency drift and/or temperature variation in the input clock signal 810.

In the example illustrated in FIG. 8, the clock buffer circuitry 812 includes multiple buffers 818a-e in order to provide multiple output clock signals 814a-d. For example, the clock buffer circuitry 812 may provide different output clock signals 814a-d of the same or differing qualities. For instance, each of the buffers 818a-e may provide a range of clock signal 814 qualities, including a highest quality clock signal 814 corresponding to a highest quality operating mode and one or more reduced quality clock signals 814 corresponding to one or more reduced quality operating modes. It should be noted that a highest quality clock signal 814 provided from one buffer 818 may differ from a highest quality clock signal 814 provided from another buffer 818. For example, each of the recipient circuitries 816a-d may require a different highest quality clock signal 814 for proper operation in highest quality operating modes.

Each of the buffers 818a-e may provide differing clock signals. For example, analog buffer A 818a may provide (analog) output clock signal A 814a and analog buffer B 818b may provide (analog) output clock signal B 814b. However, digital buffer E 818e may provide a digital clock signal, digital buffer C 818c may provide (digital) output clock signal C 814c and digital buffer D 818d may provide (digital) clock signal D 814d. Each of the output clock signals 814a-d may have similar or differing qualities.

Each of the output clock signals 814a-d may be provided to corresponding recipient circuitries 816a-d. For example, output clock signal A 814a may be provided to recipient circuitry A 816a, output clock signal B 814b may be provided to recipient circuitry B 816b, output clock signal C 814c may be provided to recipient circuitry C 816c and output clock signal D 814d may be provided to recipient circuitry D 816d.

Each buffer 818a-e may operate based on a corresponding drive signal 806a-e. For example, each buffer 818a-e may modify the input clock signal 810 (or a derivative thereof) to produce output clock signals 814a-d based on drive signal 806a-e strengths. For instance, the buffers 818a-d may provide a “cleaner” or higher quality output clock signals 814a-d with increased drive signal 806a-e strength. Reduced drive signal 806a-e strength may provide reduced clock signal 814a-d quality.

In some configurations, differing buffers 818a-e may modify the input clock signal 810 in different ways. For example, digital buffer E 818e may convert the input clock signal 810 into a digital signal, while digital buffer C 818c may reduce phase noise.

The recipient circuitries 816a-d may use the output clock signals 814a-d to perform one or more operations. Examples of recipient circuitry 816 include processors, global positioning system (GPS) circuitry, Bluetooth circuitry, a frequency modulation (FM) receiver chip, interface circuitry (e.g., ports, etc.), signal processing circuitry (e.g., radio frequency (RF) chips), communications circuitry (e.g., modulators, demodulators, encoders, etc.) and/or timers, etc. For instance, the recipient circuitries 816a-d may use the output clock signal 814 to execute instructions, receive a signal, transmit a signal, encode a signal, decode a signal, modulate a signal, demodulate a signal, track time and/or coordinate communications, etc.

One or more of the recipient circuitries 816a-d may function according to differing operating modes. For example, each of the recipient circuitries 816a-d may require particular output clock signal 814a-d qualities while in differing operating modes. One or more of the recipient circuitries 816a-d may send an operating mode indicator 804 to the mode control circuitry 802. Each operating mode indicator 804 may explicitly or implicitly indicate an operating mode for one or more recipient circuitries 816a-d. The mode control circuitry 802 may control the drive signals 806a-e based on the operating mode indicator 804.

In the example illustrated in FIG. 8, the mode control circuitry 802 may include mode mapping circuitry 860 and one or more registers 862. The mode mapping circuitry 860 may map the operating mode indicator(s) 804 to register bits that control drive signal 806a-e strength. For example, if an operating mode indicator 804 indicates that a high quality output clock signal 814a is required for recipient circuitry A 816a, the mode mapping circuitry 860 may produce a set of corresponding register bits. The register bits may configure the one or more registers 862 to increase the strength of drive signal A 806a in order to cause analog buffer A 818a to provide a high quality output clock signal A 814a. The mode control circuitry 802 may similarly decrease the strength of drive signal A 806a when an operating mode indicator 804 corresponding to recipient circuitry A 816a indicates that a lower quality output clock signal A 814a is sufficient.

In some configurations, the mode control circuitry 802 may operate according to one or more sets of operating modes. Each set of operating modes may correspond to one or more recipient circuitries 816a-d. For instance, each recipient circuitry 816a-d may have a highest quality operating mode and one or more reduced quality operating modes. In one configuration, the mode control circuitry 802 may provide minimum (with some margin, for example) drive signal 806a-e strengths in order to provide clock signal 814a-d qualities that are sufficient to satisfy the current operating modes of the recipient circuitries 816a-d. However, the mode control circuitry 802 may not provide (except with some margin, for example) higher drive signal 806a-e strengths and higher output clock signal 814a-d qualities than are needed for all of the recipient circuitries 816a-d to function properly according to operating modes in one configuration. More specifically, the mode control circuitry 802 may not operate according to a higher quality operating mode if a lesser (reduced) quality operating mode is available that will still allow proper functioning of the recipient circuitries 816a-d according to their several operating modes, for instance. This approach may conserve power or reduce wasted power. The operating modes (and hence, drive signal 806a-e strengths and output clock signal 814a-d qualities) may vary in time.

In some configurations, one or more operating mode indicators 804 may additionally or alternatively be provided from circuitry other than the recipient circuitries 816a-d. For example, controller circuitry (not illustrated in FIG. 8) may dictate when an operating mode may change in addition to or alternatively from the recipient circuitries 816a-d. In such a case, the controller circuitry may provide one or more operating mode indicators 804 to the mode control circuitry 802.

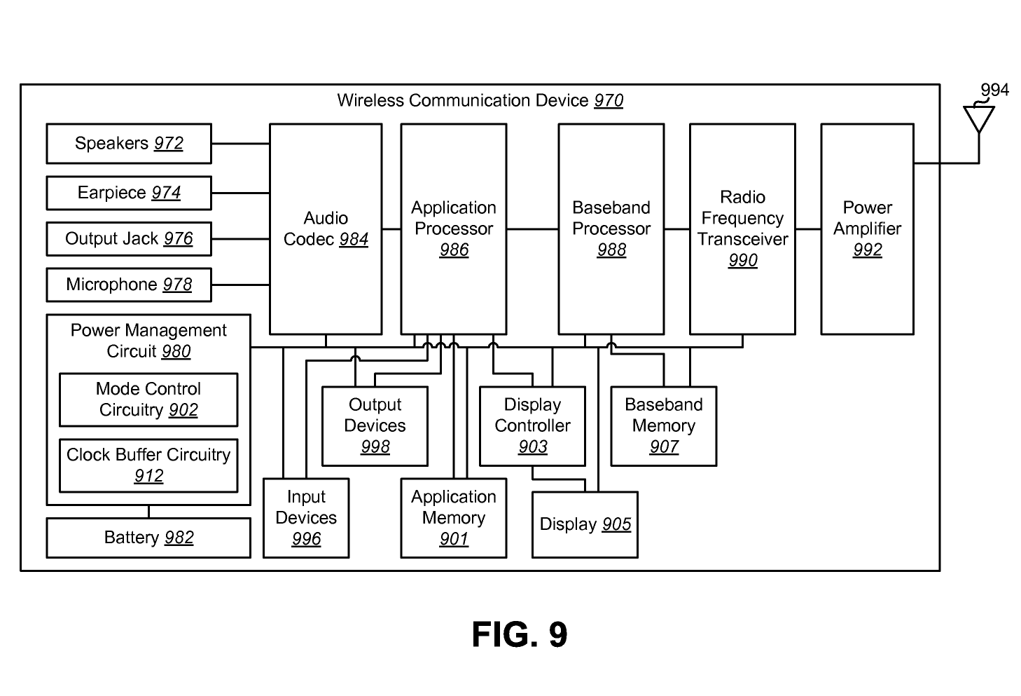

FIG. 9 is a block diagram illustrating one configuration of a wireless communication device 970 in which systems and methods for dynamically adjusting clock buffer circuitry 912 for power conservation may be implemented. Examples of wireless communication devices 970 include cellular phones, smartphones, tablet devices, laptop computers, personal digital assistants (PDAs), etc. The wireless communication device 970 may include an application processor 986. The application processor 986 generally processes instructions (e.g., runs programs) to perform functions on the wireless communication device 970. The application processor 986 may be coupled to an audio coder/decoder (codec) 984.

The audio codec 984 may be an electronic device (e.g., integrated circuit) used for coding and/or decoding audio signals. The audio codec 984 may be coupled to one or more speakers 972, an earpiece 974, an output jack 976 and/or one or more microphones 978. The speakers 972 may include one or more electro-acoustic transducers that convert electrical or electronic signals into acoustic signals. For example, the speakers 972 may be used to play music or output a speakerphone conversation, etc. The earpiece 974 may be another speaker or electro-acoustic transducer that can be used to output acoustic signals (e.g., speech signals) to a user. For example, the earpiece 974 may be used such that only a user may reliably hear the acoustic signal. The output jack 976 may be used for coupling other devices to the wireless communication device 970 for outputting audio, such as headphones. The speakers 972, earpiece 974 and/or output jack 976 may generally be used for outputting an audio signal from the audio codec 984. The one or more microphones 978 may be one or more acousto-electric transducers that convert an acoustic signal (such as a user's voice) into electrical or electronic signals that are provided to the audio codec 984.

The application processor 986 may also be coupled to a power management circuit 980. One example of the power management circuit 980 is a power management integrated circuit (PMIC), which may be used to manage the electrical power consumption of the wireless communication device 970. The power management circuit 980 may be coupled to a battery 982. The battery 982 may generally provide electrical power to the wireless communication device 970.

The power management circuit 980 may include mode control circuitry 902. One or more of the mode control circuitries 102, 402, 502, 602, 702, 802 described above may be examples of the mode control circuitry 902 illustrated in FIG. 9. The mode control circuitry 902 may be used to perform one or more of the methods 200, 300 described above.

The power management circuit 980 may additionally include clock buffer circuitry 912. One or more of the clock buffer circuitries 112, 412, 512, 612, 712, 812 described above may be examples of the clock buffer circuitry 912 illustrated in FIG. 9. The clock buffer circuitry 912 may be used to perform one or more of the methods 200, 300 described above. The mode control circuitry 902 and/or the clock buffer circuitry 912 may be used to conserve battery 982 power in accordance with the systems and methods described herein.

The power management circuitry 858 illustrated in FIG. 8 may be one example of the power management circuit 980 illustrated in FIG. 9. As shown in FIG. 9, the power management circuit 980 may be coupled to the audio codec 984, application processor 986, baseband processor 988, RF transceiver 990, input devices 996, output devices 998, application memory 901, display controller 903, display 905 and/or baseband memory 907. One or more of these elements 984, 986, 988, 990, 996, 998, 901, 903, 905, 907 may be examples of the recipient circuitries 116, 416, 516, 616, 716, 816 described above.

The application processor 986 may be coupled to one or more input devices 996 for receiving input. Examples of input devices 996 include infrared sensors, image sensors, accelerometers, touch sensors, keypads, etc. The input devices 996 may allow user interaction with the wireless communication device 970. The application processor 986 may also be coupled to one or more output devices 998. Examples of output devices 998 include printers, projectors, screens, haptic devices, etc. The output devices 998 may allow the wireless communication device 970 to produce output that may be experienced by a user.

The application processor 986 may be coupled to application memory 901. The application memory 901 may be any electronic device that is capable of storing electronic information. Examples of application memory 901 include double data rate synchronous dynamic random access memory (DDRAM), synchronous dynamic random access memory (SDRAM), flash memory, etc. The application memory 901 may provide storage for the application processor 986. For instance, the application memory 901 may store data and/or instructions for the functioning of programs that are run on the application processor 986.

The application processor 986 may be coupled to a display controller 903, which in turn may be coupled to a display 905. The display controller 903 may be a hardware block that is used to generate images on the display 905. For example, the display controller 903 may translate instructions and/or data from the application processor 986 into images that can be presented on the display 905. Examples of the display 905 include liquid crystal display (LCD) panels, light emitting diode (LED) panels, cathode ray tube (CRT) displays, plasma displays, etc.

The application processor 986 may be coupled to a baseband processor 988. The baseband processor 988 generally processes communication signals. For example, the baseband processor 988 may demodulate and/or decode received signals. Additionally or alternatively, the baseband processor 988 may encode and/or modulate signals in preparation for transmission.

The baseband processor 988 may be coupled to baseband memory 907. The baseband memory 907 may be any electronic device capable of storing electronic information, such as SDRAM, DDRAM, flash memory, etc. The baseband processor 988 may read information (e.g., instructions and/or data) from and/or write information to the baseband memory 907. Additionally or alternatively, the baseband processor 988 may use instructions and/or data stored in the baseband memory 907 to perform communication operations.

The baseband processor 988 may be coupled to a radio frequency (RF) transceiver 990. The RF transceiver 990 may be coupled to a power amplifier 992 and one or more antennas 994. The RF transceiver 990 may transmit and/or receive radio frequency signals. For example, the RF transceiver 990 may transmit an RF signal using a power amplifier 992 and one or more antennas 994. The RF transceiver 990 may also receive RF signals using the one or more antennas 994.

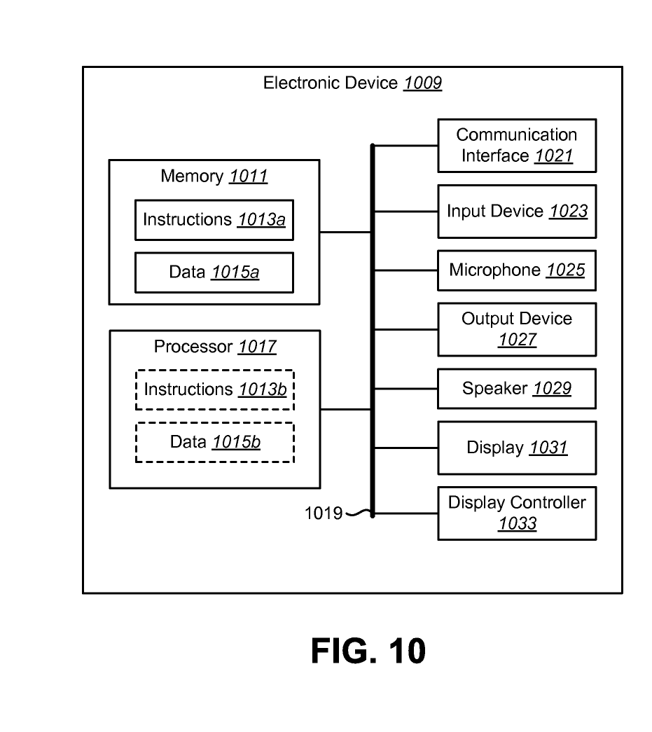

FIG. 10 illustrates various components that may be utilized in an electronic device 1009. The illustrated components may be located within the same physical structure or in separate housings or structures. The electronic device 1009 may include one or more of the clock buffer circuitries 112, 412, 512, 612, 712, 812, 912 and/or mode control circuitries 102, 402, 502, 602, 702, 802, 902 described previously. The electronic device 1009 includes a processor 1017. The processor 1017 may be a general purpose single- or multi-chip microprocessor (e.g., an ARM), a special purpose microprocessor (e.g., a digital signal processor (DSP)), a microcontroller, a programmable gate array, etc. The processor 1017 may be referred to as a central processing unit (CPU). Although just a single processor 1017 is shown in the electronic device 1009 of FIG. 10, in an alternative configuration, a combination of processors (e.g., an ARM and DSP) could be used.

The electronic device 1009 also includes memory 1011 in electronic communication with the processor 1017. That is, the processor 1017 can read information from and/or write information to the memory 1011. The memory 1011 may be any electronic component capable of storing electronic information. The memory 1011 may be random access memory (RAM), read-only memory (ROM), magnetic disk storage media, optical storage media, flash memory devices in RAM, on-board memory included with the processor, programmable read-only memory (PROM), erasable programmable read-only memory (EPROM), electrically erasable PROM (EEPROM), registers, and so forth, including combinations thereof.

Data 1015a and instructions 1013a may be stored in the memory 1011. The instructions 1013a may include one or more programs, routines, sub-routines, functions, procedures, etc. The instructions 1013a may include a single computer-readable statement or many computer-readable statements. The instructions 1013a may be executable by the processor 1017 to implement one or more of the methods 200, 300 described above. Executing the instructions 1013a may involve the use of the data 1015a that is stored in the memory 1011. FIG. 10 shows some instructions 1013b and data 1015b being loaded into the processor 1017 (which may come from instructions 1013a and data 1015a).

The electronic device 1009 may also include one or more communication interfaces 1021 for communicating with other electronic devices. The communication interfaces 1021 may be based on wired communication technology, wireless communication technology, or both. Examples of different types of communication interfaces 1021 include a serial port, a parallel port, a Universal Serial Bus (USB), an Ethernet adapter, an IEEE 1394 bus interface, a small computer system interface (SCSI) bus interface, an infrared (IR) communication port, a Bluetooth wireless communication adapter, and so forth.

The electronic device 1009 may also include one or more input devices 1023 and one or more output devices 1027. Examples of different kinds of input devices 1023 include a keyboard, mouse, microphone, remote control device, button, joystick, trackball, touchpad, lightpen, etc. For instance, the electronic device 1009 may include one or more microphones 1025 for capturing acoustic signals. In one configuration, a microphone 1025 may be a transducer that converts acoustic signals (e.g., voice, speech) into electrical or electronic signals. Examples of different kinds of output devices 1027 include a speaker, printer, etc. For instance, the electronic device 1009 may include one or more speakers 1029. In one configuration, a speaker 1029 may be a transducer that converts electrical or electronic signals into acoustic signals. One specific type of output device which may be typically included in an electronic device 1009 is a display device 1031. Display devices 1031 used with configurations disclosed herein may utilize any suitable image projection technology, such as a cathode ray tube (CRT), liquid crystal display (LCD), light-emitting diode (LED), gas plasma, electroluminescence, or the like. A display controller 1033 may also be provided, for converting data stored in the memory 1011 into text, graphics, and/or moving images (as appropriate) shown on the display device 1031.

The various components of the electronic device 1009 may be coupled together by one or more buses, which may include a power bus, a control signal bus, a status signal bus, a data bus, etc. For simplicity, the various buses are illustrated in FIG. 10 as a bus system 1019. It should be noted that FIG. 10 illustrates only one possible configuration of an electronic device 1009. Various other architectures and components may be utilized.

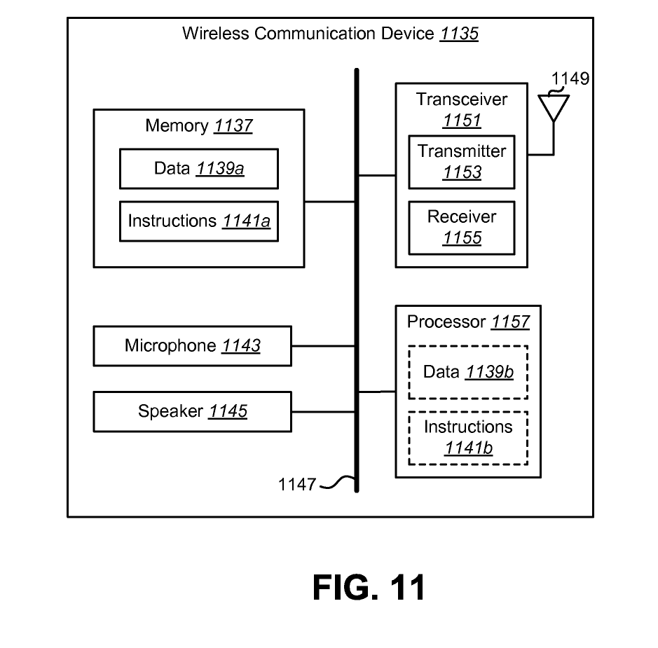

FIG. 11 illustrates certain components that may be included within a wireless communication device 1135. The wireless communication device 1135 may include one or more of the clock buffer circuitries 112, 412, 512, 612, 712, 812, 912 and/or mode control circuitries 102, 402, 502, 602, 702, 802, 902 described previously.

The wireless communication device 1135 includes a processor 1157. The processor 1157 may be a general purpose single- or multi-chip microprocessor (e.g., an ARM), a special purpose microprocessor (e.g., a digital signal processor (DSP)), a microcontroller, a programmable gate array, etc. The processor 1157 may be referred to as a central processing unit (CPU). Although just a single processor 1157 is shown in the wireless communication device 1135 of FIG. 11, in an alternative configuration, a combination of processors (e.g., an ARM and DSP) could be used.

The wireless communication device 1135 also includes memory 1137 in electronic communication with the processor 1157 (i.e., the processor 1157 can read information from and/or write information to the memory 1137). The memory 1137 may be any electronic component capable of storing electronic information. The memory 1137 may be random access memory (RAM), read-only memory (ROM), magnetic disk storage media, optical storage media, flash memory devices in RAM, on-board memory included with the processor, programmable read-only memory (PROM), erasable programmable read-only memory (EPROM), electrically erasable PROM (EEPROM), registers, and so forth, including combinations thereof.

Data 1139a and instructions 1141a may be stored in the memory 1137. The instructions 1141a may include one or more programs, routines, sub-routines, functions, procedures, code, etc. The instructions 1141a may include a single computer-readable statement or many computer-readable statements. The instructions 1141a may be executable by the processor 1157 to implement one or more of the methods 200, 300 described above. Executing the instructions 1141a may involve the use of the data 1139a that is stored in the memory 1137. FIG. 11 shows some instructions 1141b and data 1139b being loaded into the processor 1157 (which may come from instructions 1141a and data 1139a).

The wireless communication device 1135 may also include a transmitter 1153 and a receiver 1155 to allow transmission and reception of signals between the wireless communication device 1135 and a remote location (e.g., another electronic device, wireless communication device, etc.). The transmitter 1153 and receiver 1155 may be collectively referred to as a transceiver 1151. An antenna 1149 may be electrically coupled to the transceiver 1151. The wireless communication device 1135 may also include (not shown) multiple transmitters, multiple receivers, multiple transceivers and/or multiple antenna.

In some configurations, the wireless communication device 1135 may include one or more microphones 1143 for capturing acoustic signals. In one configuration, a microphone 1143 may be a transducer that converts acoustic signals (e.g., voice, speech) into electrical or electronic signals. Additionally or alternatively, the wireless communication device 1135 may include one or more speakers 1145. In one configuration, a speaker 1145 may be a transducer that converts electrical or electronic signals into acoustic signals.

The various components of the wireless communication device 1135 may be coupled together by one or more buses, which may include a power bus, a control signal bus, a status signal bus, a data bus, etc. For simplicity, the various buses are illustrated in FIG. 11 as a bus system 1147.

In the above description, reference numbers have sometimes been used in connection with various terms. Where a term is used in connection with a reference number, this may be meant to refer to a specific element that is shown in one or more of the Figures. Where a term is used without a reference number, this may be meant to refer generally to the term without limitation to any particular Figure.

The term “determining” encompasses a wide variety of actions and, therefore, “determining” can include calculating, computing, processing, deriving, investigating, looking up (e.g., looking up in a table, a database or another data structure), ascertaining and the like. Also, “determining” can include receiving (e.g., receiving information), accessing (e.g., accessing data in a memory) and the like. Also, “determining” can include resolving, selecting, choosing, establishing and the like.

The phrase “based on” does not mean “based only on,” unless expressly specified otherwise. In other words, the phrase “based on” describes both “based only on” and “based at least on.”

The functions described herein may be stored as one or more instructions on a processor-readable or computer-readable medium. The term “computer-readable medium” refers to any available medium that can be accessed by a computer or processor. By way of example, and not limitation, such a medium may comprise RAM, ROM, EEPROM, flash memory, CD-ROM or other optical disk storage, magnetic disk storage or other magnetic storage devices, or any other medium that can be used to store desired program code in the form of instructions or data structures and that can be accessed by a computer or processor. Disk and disc, as used herein, includes compact disc (CD), laser disc, optical disc, digital versatile disc (DVD), floppy disk and Blu-ray® disc where disks usually reproduce data magnetically, while discs reproduce data optically with lasers. It should be noted that a computer-readable medium may be tangible and non-transitory. The term “computer-program product” refers to a computing device or processor in combination with code or instructions (e.g., a “program”) that may be executed, processed or computed by the computing device or processor. As used herein, the term “code” may refer to software, instructions, code or data that is/are executable by a computing device or processor.

Software or instructions may also be transmitted over a transmission medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of transmission medium.

The methods disclosed herein comprise one or more steps or actions for achieving the described method. The method steps and/or actions may be interchanged with one another without departing from the scope of the claims. In other words, unless a specific order of steps or actions is required for proper operation of the method that is being described, the order and/or use of specific steps and/or actions may be modified without departing from the scope of the claims.

It is to be understood that the claims are not limited to the precise configuration and components illustrated above. Various modifications, changes and variations may be made in the arrangement, operation and details of the systems, methods, and apparatus described herein without departing from the scope of the claims.

What is claimed is:

1. Circuitry configured for dynamically adjusting clock signal quality based on an operating mode for power savings, comprising:
clock generation circuitry;
mode control circuitry, wherein the mode control circuitry provides a drive signal based on an operating mode; and
clock buffer circuitry coupled to the clock generation circuitry and to the mode control circuitry, wherein the clock buffer circuitry adjusts a clock signal quality based on the drive signal.

2. The circuitry of claim 1, wherein the clock signal quality is continually adjusted based on an operating mode indicator.

3. The circuitry of claim 1, wherein a drive signal strength is reduced and the clock signal quality is reduced for a reduced quality operating mode.

4. The circuitry of claim 3, wherein reducing the drive signal strength conserves power.

5. The circuitry of claim 1, wherein a drive signal strength is increased and the clock signal quality is increased for a highest quality operating mode.

6. The circuitry of claim 1, wherein the operating mode is based on the clock signal quality required for proper operation of recipient circuitry.

7. The circuitry of claim 1, wherein the clock signal quality is based on one of a group consisting of phase noise, frequency drift, amplitude, temperature compensation, jitter and another clock quality parameter.

8. The circuitry of claim 1, wherein the clock generation circuitry comprises a crystal and crystal oscillator circuitry.

9. The circuitry of claim 1, wherein the mode control circuitry and the clock buffer circuitry are included in a power management circuit.

10. The circuitry of claim 1, wherein the mode control circuitry and the clock buffer circuitry are included in an electronic device.

11. A method for dynamically adjusting clock signal quality by circuitry based on an operating mode for power savings, comprising:
generating a clock signal;
providing a drive signal based on an operating mode; and
adjusting a clock signal quality based on the drive signal.

12. The method of claim 11, wherein the clock signal quality is continually adjusted based on an operating mode indicator.

13. The method of claim 11, wherein a drive signal strength is decreased and the clock signal quality is decreased for a reduced quality operating mode.

14. The method of claim 13, wherein decreasing the drive signal strength conserves power.

15. The method of claim 11, wherein a drive signal strength is increased and the clock signal quality is increased for a highest quality operating mode.

16. The method of claim 11, wherein the operating mode is based on the clock signal quality required for proper operation of recipient circuitry.

17. The method of claim 11, wherein the clock signal quality is based on one of a group consisting of phase noise, frequency drift, amplitude, temperature compensation, jitter and another clock quality parameter.

18. The method of claim 11, wherein the clock signal is generated using a crystal and crystal oscillator circuitry.

19. The method of claim 11, wherein the method is performed by circuitry included in a power management circuit.

20. The method of claim 11, wherein the method is performed by circuitry included in an electronic device.

21. A computer-program product for dynamically adjusting clock signal quality based on an operating mode for power savings, comprising a non-transitory tangible computer-readable medium having instructions thereon, the instructions comprising:
code for causing circuitry to generate a clock signal;
code for causing the circuitry to provide a drive signal based on an operating mode; and
code for causing the circuitry to adjust a clock signal quality based on the drive signal.

22. The computer-program product of claim 21, wherein the clock signal quality is continually adjusted based on an operating mode indicator.

23. The computer-program product of claim 21, wherein a drive signal strength is decreased and the clock signal quality is decreased for a reduced quality operating mode.

24. The computer-program product of claim 23, wherein decreasing the drive signal strength conserves power.

25. The computer-program product of claim 21, wherein a drive signal strength is increased and the clock signal quality is increased for a highest quality operating mode.

26. The computer-program product of claim 21, wherein the clock signal quality is based on one of a group consisting of phase noise, frequency drift, amplitude, temperature compensation, jitter and another clock quality parameter.

27. An apparatus for dynamically adjusting clock signal quality based on an operating mode for power savings, comprising:
means for generating a clock signal;
means for providing a drive signal based on an operating mode; and
means for adjusts a clock signal quality based on the drive signal.

28. The apparatus of claim 27, wherein the clock signal quality is continually adjusted based on an operating mode indicator.

29. The apparatus of claim 27, wherein a drive signal strength is decreased and the clock signal quality is decreased for a reduced quality operating mode.

30. The apparatus of claim 29, wherein decreasing the drive signal strength conserves power.

31. The apparatus of claim 27, wherein a drive signal strength is increased and the clock signal quality is increased for a highest quality operating mode.

32. The apparatus of claim 27, wherein the clock signal quality is based on one of a group consisting of phase noise, frequency drift, amplitude, temperature compensation, jitter and another clock quality parameter.
